(19) United States
(12) Patent Application Publication
(10) Pub. No.: US 2016/0315299 A1
(43) Pub. Date: Oct. 27, 2016

(54) BATTERY MODULE

(71) Applicant: PANASONIC INTELLECTUAL PROPERTY MANAGEMENT CO., LTD., Osaka-shi (JP)

(72) Inventors: DAISUKE KISHII, Osaka (JP); TOMOHIKO YOKOYAMA, Osaka (JP)

(73) Assignee: Panasonic Intellectual Property Management Co., Ltd., Osaka (JP)

(21) Appl. No.: 15/103,853

(22) PCT Filed: Dec. 10, 2014
(86) PCT No.: PCT/JP2014/006156

§ 371 Date: Jun. 11, 2016

(30) Foreign Application Priority Data
Dec. 26, 2013 (JP) 2013-268663

(51) Int. Cl. H01M 2/10; H01M 10/02; H01M 10/6556; H01M 2/20; H01M 10/625

(52) U.S. Cl. CPC H01M 2/1077; H01M 2/1083; H01M 2/206; H01M 10/625; H01M 10/6556; H01M 10/02; H01M 2220/20

(57) ABSTRACT

A first battery block has a first cut-away part on a side surface facing a second battery block. The second battery block has a second cut-away part on a side surface facing the first cut-away part such that the second cut-away part faces the first cut-away part. A battery module is provided with a space surrounded by the side surface on which the first battery block has the first cut-away part, the side surface on which the second battery block has the second cut-away part, and an inner side surface of the battery case.

### TECHNICAL FIELD

The present disclosure relates to a battery module having a plurality of battery blocks housed in a battery case.

### BACKGROUND ART

In order to obtain a desired voltage and a desired current, a battery block including a plurality of batteries connected to one another and held in a battery holder is used, and a battery module including a plurality of battery blocks connected to one another is further used.

### CITATION LIST

### Patent Literature

PTL 1: Unexamined Japanese Patent Publication No. 2001-229900

### SUMMARY OF THE INVENTION

### Technical Problem

PTL 1 discloses that, in a case where external force is applied to an airtight container (battery case) that houses batteries, resilient plastic deformation of a part of each of partition walls inside of the airtight container is caused to alleviate the external force applied to the airtight container. In a case where such a part of the airtight container resiliently plastically deforms, there is concern that stress owing to the deformation is applied to the batteries to cause breakage, internal short circuits, or the like of the batteries.

The present disclosure describes a battery module in which breakage or internal short circuits of batteries owing to external force is prevented.

### Solution to Problem

A battery module according to the present disclosure includes a first battery block that houses a plurality of batteries, a second battery block that houses a plurality of batteries, and a battery case that houses the first battery block and the second battery block such that the first battery block and the second battery block are disposed side by side. The plurality of batteries housed in the first battery block is housed in the first battery block such that longitudinal directions of the plurality of batteries are directed to the same direction. The plurality of batteries housed in the second battery block is housed in the second battery block such that longitudinal directions of the plurality of batteries are directed to the same direction. The first battery block and the second battery block are each polygonal in plan view when the plurality of batteries is viewed in the longitudinal directions. The first battery block has a first cut-away part on a side surface facing the second battery block. The second battery block has a second cut-away part on a side surface facing the first cut-away part such that the second cut-away part faces the first cut-away part. The battery module is provided with a space surrounded by the side surface on which the first battery block has the first cut-away part, the side surface on which the second battery block has the second cut-away part, and an inner side surface of the battery case.

### Advantageous Effect of Invention

In the battery module according to the present disclosure, it is possible to prevent breakage or internal short circuits of batteries owing to external force.

### BRIEF DESCRIPTION OF DRAWINGS

FIG. 1 is a perspective view illustrating a configuration of a battery module according to an exemplary embodiment.

FIG. 2 is an exploded view of a battery module according to a first exemplary embodiment.

FIG. 3 is a sectional view taken along line A-A of the battery module according to the first exemplary embodiment.

FIG. 4 is a perspective view of the battery module according to the first exemplary embodiment.

FIG. 5 is a sectional view taken along line A-A of FIG. 1 and illustrating the battery module according to the first exemplary embodiment when external force is applied to one of side surfaces of the battery module.

FIG. 6 is a diagram of a battery module according to a modification of the first exemplary embodiment when the battery module is viewed from an upper surface.

FIG. 7 is a perspective view of battery blocks according to the modification of the first exemplary embodiment.

FIG. 8 is a sectional view taken along line A-A of a battery module according to a second exemplary embodiment.

FIG. 9 is a perspective view of the battery module according to the second exemplary embodiment.

FIG. 10 is a sectional view taken along line A-A of FIG. 1 and illustrating the battery module according to the second exemplary embodiment when external force is applied to one of side surfaces of the battery module.

FIG. 11 is a sectional view taken along line A-A of a battery module according to a modification of the second exemplary embodiment.

FIG. 12 is a perspective view illustrating a configuration of a battery module according to a third exemplary embodiment.

FIG. 13 is a sectional view taken along line A-A of the battery module according to the third exemplary embodiment.

### DESCRIPTION OF EMBODIMENTS

Hereinafter, exemplary embodiments are described in detail with reference to the drawings. Materials, dimensions, shapes, a number of batteries, and the like described below are exemplified for the purpose of description, and can be changed suitably according to specifications of a battery case and a battery holder. In the referenced respective figures, repetitive description about substantially the same configuration may be omitted.

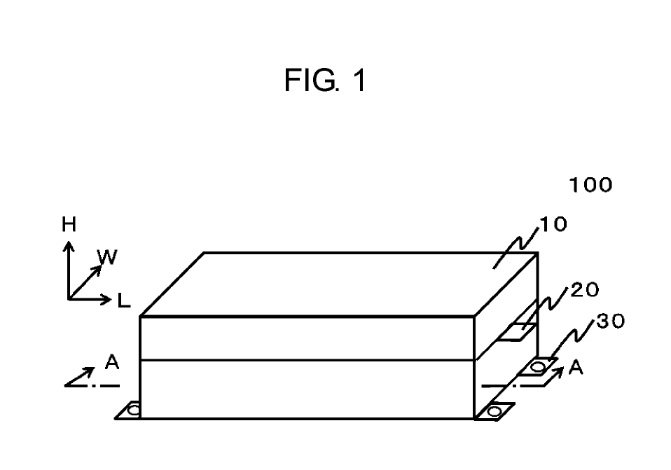

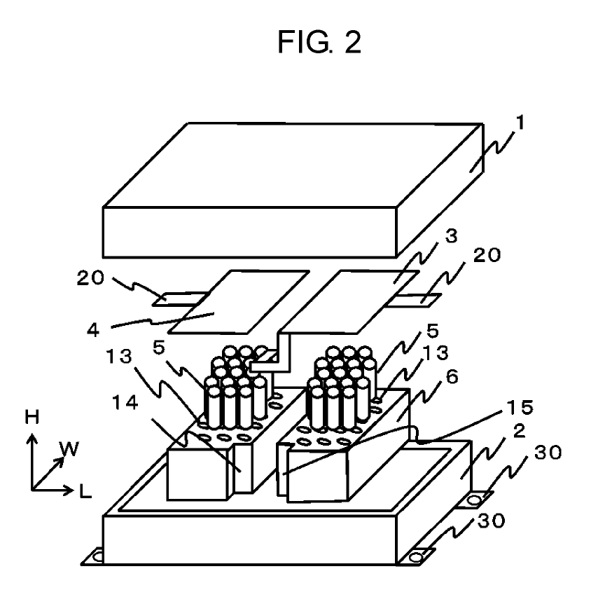

FIG. 1 is a perspective view illustrating a configuration of a battery module according to an exemplary embodiment. FIG. 2 is an exploded view of a battery module according to a first exemplary embodiment.

In FIG. 1, FIG. 2, and a part of the drawings described later, height direction H, length direction L, and width direction W are illustrated as directions of three axes orthogonal to each other. Height direction H is an up-down direction or a perpendicular direction when battery module 100 is installed on a horizontal surface. Length direction L and width direction W are directions orthogonal to each other on the horizontal surface. Here, a direction in which battery module 100 has a longer dimension is defined as length direction L, and a direction in which battery module 100 has a shorter dimension is defined as width direction W. Note that in description of the exemplary embodiments, it does not matter whether height direction H, length direction L, and width direction W each are a plus direction or a minus direction. For example, it does not matter whether height direction H extends in an up direction or in a down direction. Length direction L and width direction W are defined in a similar manner to height direction H.

Battery module 100 is formed in a rectangular parallelepiped shape. Input/output terminals 20 are formed so as to protrude from opposite end parts in length direction L of battery module 100. One of two input/output terminals 20 is a positive terminal and the other is a negative terminal. Input/output terminals 20 are electrically connected to electrodes of batteries 5 through current collectors of a plurality of battery blocks that battery module 100 includes. Batteries 5 are charged and discharged with input/output terminals 20.

Note that places for two input/output terminals 20 to be disposed are not limited to the opposite end parts in length direction L of battery module 100. The two input/output terminals can also be provided concentrically in a single terminal unit provided in an end part on one side in length direction L of battery module 100. The two input/output terminals can also be provided in an end part on one side in width direction W of battery module 100 or in opposite end parts in width direction W of battery module 100.

Battery module 100 includes a plurality of batteries 5 disposed in a staggered arrangement, and battery case 10 that houses the plurality of battery blocks. Battery module 100 is configured to have the plurality of battery blocks connected in parallel or in series so as to obtain a predetermined battery capacity. Each battery block includes a plurality of batteries 5, and battery holder 6 having housing parts 13 that house a plurality of batteries 5.

The plurality of battery blocks of battery module 100 is aligned and disposed in a predetermined arrangement relationship such that all of positive sides are aligned on one side and all of negative sides are aligned on the other side.

Battery module 100 is fixed to a member on a vehicle body side or to an installation surface inside of a housing of a power storage system. Fixtures such as bolts are attached to fixing parts 30. Note that a method for fixing fixing parts 30 is not particularly limited. For example, upper side battery case 1 and lower side battery case 2 each may have fixing parts 30 formed with hollow cylindrical shapes in height direction H, and may be attached to the member on the vehicle body side or to the installation surface inside of the housing of the power storage system by inserting bolts into hollow inner parts of fixing parts 30 so as to couple respective fixing parts 30. Additionally, fixing parts 30 may be provided inside of battery case 10, and battery module 100 may be miniaturized.

Battery case 10 is configured to include upper side battery case 1 and lower side battery case 2. Battery case 10 houses and holds the plurality of battery blocks in a predetermined arrangement relationship.

The battery blocks are disposed between upper side battery case 1 and lower side battery case 2. The battery blocks are coupled to positive current collector 3 and negative current collector 4 by suitable fastening members in a state where positive current collector 3 or negative current collector 4 is disposed on each of opposite sides of the battery blocks. A side surface of each battery block in a direction in which upper side battery case 1 is disposed is defined as an upper surface of the battery block. A side surface of each battery block in a direction in which lower side battery case 2 is disposed is defined as an undersurface of the battery block. A shape of each battery block when the battery block is viewed from the upper surface or the undersurface is polygonal in plan view.

Positive current collector 3 is disposed on a positive side of the battery block, and negative current collector 4 is disposed on a negative side of the battery block.

In a case where the plurality of battery blocks disposed side by side is connected in parallel, positive current collector 3 and negative current collector 4 disposed in the plurality of battery blocks disposed side by side are disposed in the same direction.

In a case where the plurality of battery blocks disposed side by side is connected in series, positive current collector 3 and negative current collector 4 disposed in the plurality of battery blocks disposed side by side are alternately disposed, and a connecting part that connects positive current collector 3 and negative current collector 4 along length direction L is provided. Note that miniaturization of battery module 100 can be attained by disposing the connecting part in a space surrounded by first side wall 16, third side wall 18, and battery case 10.

Lower side battery case 2 supports lower end parts of the respective battery blocks on an upper side. Additionally, lower side battery case 2 has fixing parts 30 for fixing battery module 100 to the member on the vehicle body side or to the installation surface inside of the housing of the power storage system, in opposite end parts in width direction W.

Each battery block includes batteries 5, and battery holder 6 having housing parts 13 that house batteries 5. Battery holder 6 disposes and holds a predetermined number of batteries 5 respectively in a row direction and a column direction orthogonal to the longitudinal directions of batteries 5, such that batteries 5 are aligned in a longitudinal direction of the battery holder. In FIG. 1 and FIG. 2, each battery block includes seventeen batteries 5.

Battery holder 6 is a frame body having the same height as a height of each of batteries 5. Battery holder 6 has a plurality of through holes. The through holes are housing parts 13 for holding batteries 5. Batteries 5 are housed in housing parts 13, respectively. Note that any shape of each housing part 13 may be employed as long as at least a part of each battery is housed in each through hole. Therefore, a length of each housing part 13 is not limited to a length in an axial direction of the battery.

Housing parts 13 are disposed in a staggered arrangement relationship corresponding to the arrangement relationship of batteries 5. Battery holder 6 may be made of a material with high heat conductivity. For example, a battery holder made of aluminum as a main material and formed in a predetermined shape by extrusion molding can be used as battery holder 6.

Batteries 5 are secondary batteries which can be charged and discharged. Lithium ion batteries are used as the secondary batteries. In addition, nickel hydride batteries, alkaline batteries, or the like may be used. Battery holder 6 has housing parts 13 conforming to shapes of batteries 5.

### FIRST EXEMPLARY EMBODIMENT

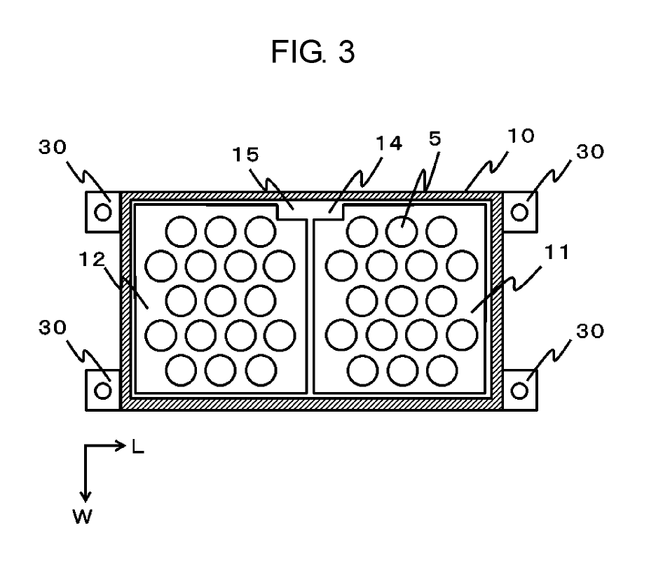

FIG. 3 is a sectional view taken along line A-A of a battery module according to the first exemplary embodiment.

Battery case 10 houses first battery block 11 and second battery block 12.

First battery block 11 has first cut-away part 14 on one of end part sides of a side surface facing second battery block 12. Second battery block 12 has second cut-away part 15 on one of end part sides of a side surface facing first battery block 11. First cut-away part 14 and second cut-away part 15 are formed when each battery holder 6 is formed by extrusion molding.

First cut-away part 14 and second cut-away part 15 are each formed in an L-shape in plan view of FIG. 3.

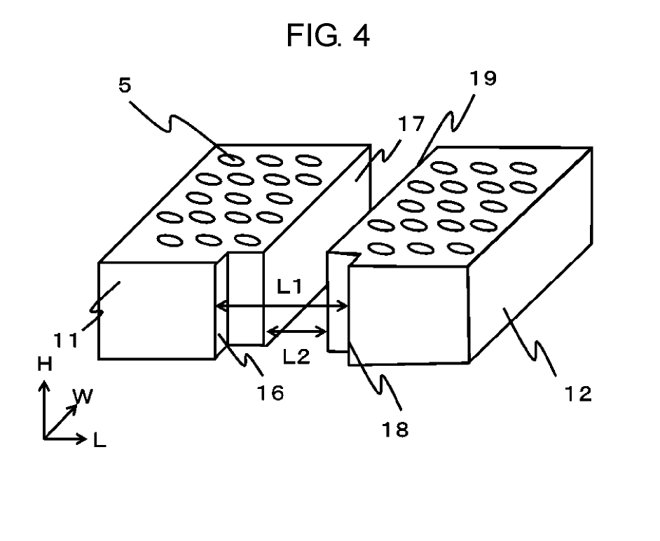

FIG. 4 is a perspective view of the battery blocks according to the first exemplary embodiment.

First battery block 11 has first side wall 16 and second side wall 17 on the side surface facing second battery block 12. Second battery block 12 has third side wall 18 and fourth side wall 19 on the side surface facing the first battery block 11.

First side wall 16 faces third side wall 18. A length (distance) in length direction L from first side wall 16 to third side wall 18 is defined as facing length L1.

Second side wall 17 faces fourth side wall 19. A length (distance) in length direction L from second side wall 17 to fourth side wall 19 is defined as facing length L2.

Facing length L1 is longer than facing length L2. An area of first side wall 16 is smaller than an area of second side wall 17. An area of third side wall 18 is smaller than an area of fourth side wall 19.

Note that a partition wall can also be provided between the facing side surfaces of first battery block 11 and second battery block 12. In a case where the partition wall is provided, a total of a length from first side wall 16 to the partition wall and a length from second side wall 17 to the partition wall is defined as facing length L1. Additionally, a total of a length from third side wall 18 to the partition wall and a length from fourth side wall 19 to the partition wall is defined as facing length L2. Also in a case where the partition wall is provided, facing length L1 is longer than facing length L2.

Note that in a case where second side wall 17 of first battery block 11 and fourth side wall 19 of second battery block 12 are in close contact with each other or integrated with each other, first side wall 16 and third side wall 18 may be formed such that facing length L1≠0 is satisfied.

A space surrounded by first side wall 16, third side wall 18, and battery case 10 is formed inside of battery case 10.

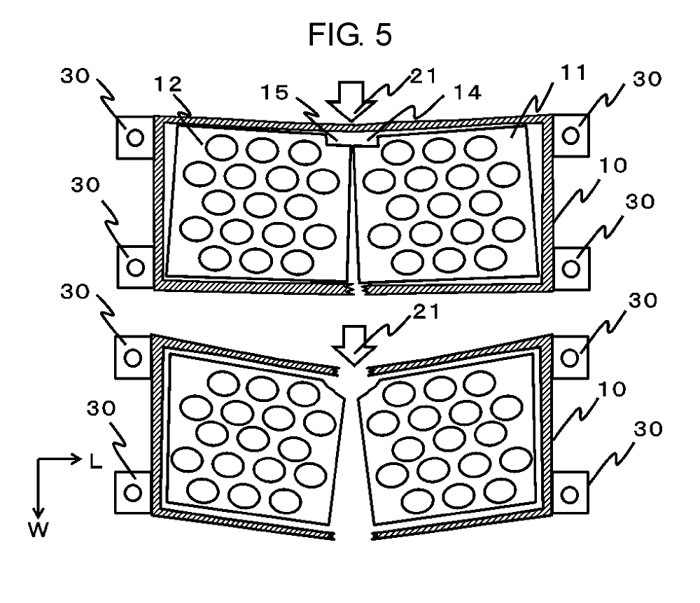

FIG. 5 is a sectional view taken along line A-A of FIG. 1 and illustrating the battery module according to the first exemplary embodiment when external force is applied to one of side surfaces of the battery module.

The one of the side surfaces of the battery module means a side surface on a side having the space surrounded by first side wall 16 and third side wall 18 and battery case 10, among side surfaces facing in height direction H and length direction L of battery case 10. The “one of the side surfaces of the battery module” is synonymous with “one of side surfaces of battery case 10.” Here, it is assumed that external force 21 is vertically applied to the one of the side surfaces of battery case 10. Additionally, a range of application of external force 21 is smaller than a range of existence of the space. The range of existence of the space is determined, for example by a range of application of external force 21, which is assumed with an apparatus to be mounted, or by an experiment.

Note that the above description about the battery blocks and the following description about the battery blocks apply to both first battery block 11 and second battery block 12. It is assumed that the following description about the cut-away parts applies to both first cut-away part 14 and second cut-away part 15. Assuming the above, the battery module when external force is applied to the one of the side surfaces of the battery module will be described.

Strain owing to external force 21 is more easily generated on the one of the side surfaces of battery case 10 in the range of existence of the space than on the one of side surfaces outside this range.

When external force 21 is applied to an outer side surface of the one of the side surfaces of battery case 10 in a direction of an arrow, strain is generated toward the other side surface of battery case 10 on the one of the side surfaces of battery case 10 which has received external force 21. Battery case 10 is compressed in width direction W. Note that the other side surface of battery case 10 is a side surface facing the one of the side surfaces of battery case 10.

An inner side surface of the one of the side surfaces of battery case 10 to which external force 21 is applied is compressed until the inner side surface comes into contact with the battery blocks.

The battery blocks are compressed in width direction W by external force 21 until end parts (angular parts) of the battery blocks being in contact with second side wall 17 and fourth side wall 19 come into contact with an inner side surface of the other side surface of battery case 10.

The space is compressed in width direction W by external force 21, and compressed until the inner side surface of the one of the side surfaces of battery case 10 comes into contact with the cut-away parts.

Arcuate strain is generated mainly in the range of existence of the space in battery case 10. The end parts (angular parts) of the battery blocks being in contact with second side wall 17 and fourth side wall 19 come into contact with the inner side surface of the other side surface of battery case 10.

External force 21 compresses first side wall 16, second side wall 17, third side wall 18, and fourth side wall 19 in width direction W. The compression sometimes decreases the area of first side wall 16 and the area of third side wall 18.

Facing length L2 between compressed second side wall 17 and fourth side wall 19 increases toward the other side surface of battery case 10. The end parts (angular parts) of the battery blocks being in contact with second side wall 17 and fourth side wall 19 transmits external force 21 to the inner side surface of the other side surface of battery case 10.

External force 21 is applied from the end parts (angular parts) of the battery blocks being in contact with second side wall 17 and fourth side wall 19 to the inner side surface of the other side surface of battery case 10 concentrically, and therefore cracks are generated along height direction H on the other side surface of battery case 10 being in contact with the end parts (angular parts) of the battery blocks being in contact with second side wall 17 and fourth side wall 19.

Cracks are generated along height direction H also on the one of the side surfaces of battery case 10 in a vicinity to which external force 21 is applied.

When external force 21 further continues to be applied, cracks are generated along width direction W on side surfaces defined by length direction L and width direction W such that the cracks on the one of the side surfaces of battery case 10 are connected to the cracks on the other side surface. A whole circumference of battery case 10 ruptures, and battery case 10 collapses.

According to the above configuration, battery case 10 collapses such that the whole circumference of battery case 10 ruptures, and thus it is possible to avoid application of external force 21 in an extent of generating breakage or internal short circuits in batteries 5.

According to the above configuration, since it is possible to control a rupture and collapse state of battery case 10, it is possible to suppress application of stress owing to deformation of battery case 10 to the batteries, and it is possible to prevent breakage of batteries 5 and internal short circuits of batteries 5 owing to the breakage.

### MODIFICATION OF FIRST EXEMPLARY EMBODIMENT

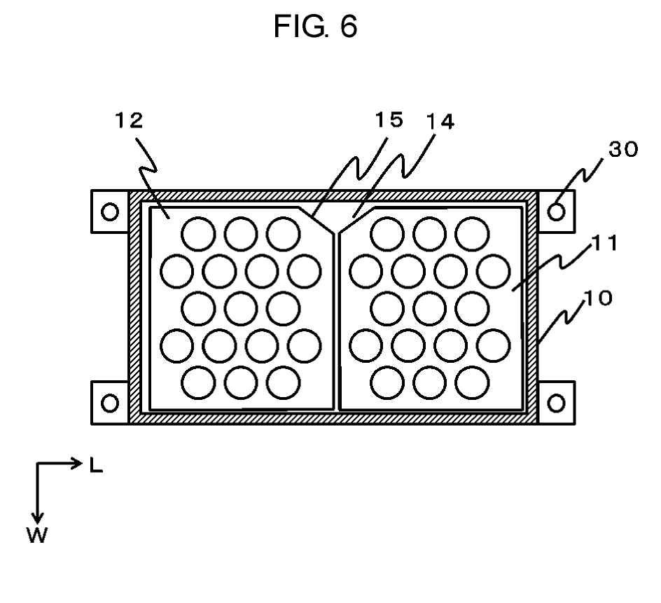

FIG. 6 is a diagram of battery blocks according to a modification of the first exemplary embodiment when the battery blocks are viewed from upper surfaces. Parts different from the parts of the first exemplary embodiment will mainly be described.

First battery block 11 and second battery block 12 have first cut-away part 14 and second cut-away part 15 on ones of end part sides of facing side surfaces, respectively. First battery block 11 and second battery block 12 are each formed in a pentagon in plan view of FIG. 6.

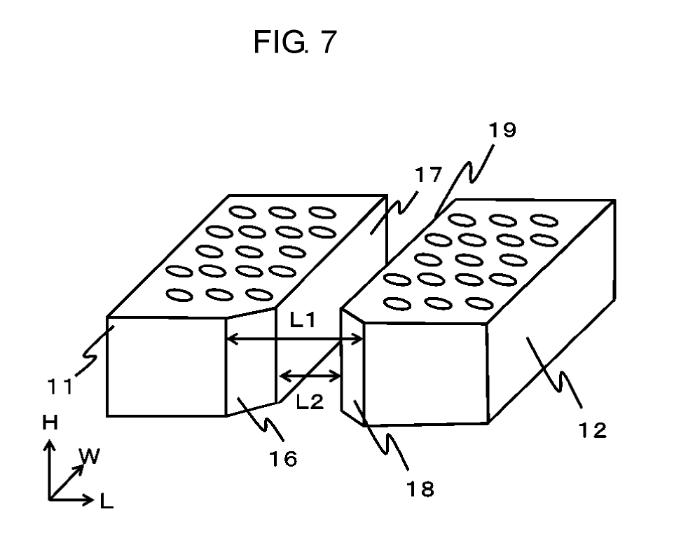

FIG. 7 is a perspective view of the battery blocks according to the modification of the first exemplary embodiment.

First battery block 11 has first side wall 16 and second side wall 17 on the side surface in width direction W facing second battery block 12. Second battery block 12 has third side wall 18 and fourth side wall 19 on the side surface in width direction W facing the first battery block 11.

First side wall 16 faces third side wall 18. A length (distance) in length direction L from first side wall 16 to third side wall 18 is defined as facing length L1.

Second side wall 17 faces fourth side wall 19. A length (distance) in length direction L from second side wall 17 to fourth side wall 19 is defined as facing length L2.

Facing length L1 is formed so as to decrease toward third side wall 18 or fourth side wall 19.

A space surrounded by first side wall 16, third side wall 18, and battery case 10 is formed inside of battery case 10.

According to the above configuration, when external force 21 is applied to one of side surfaces of battery case 10 in a range of facing the cut-away parts, strain is generated toward the other side surface of battery case 10 on the one of the side surfaces of battery case 10 which has received external force 21. Battery case 10 is compressed in width direction W.

In a case where external force 21 is applied and strain is generated in width direction W of battery case 10, a contact area of an inner side surface of the strained one of the side surfaces of battery case 10 with first side wall 16 and third side wall 18 increases. Therefore, it is possible to increase external force 21 applied to first side wall 16 and third side wall 18, and it is possible to cause can rupture and collapse of battery case 10 with small force.

### SECOND EXEMPLARY EMBODIMENT

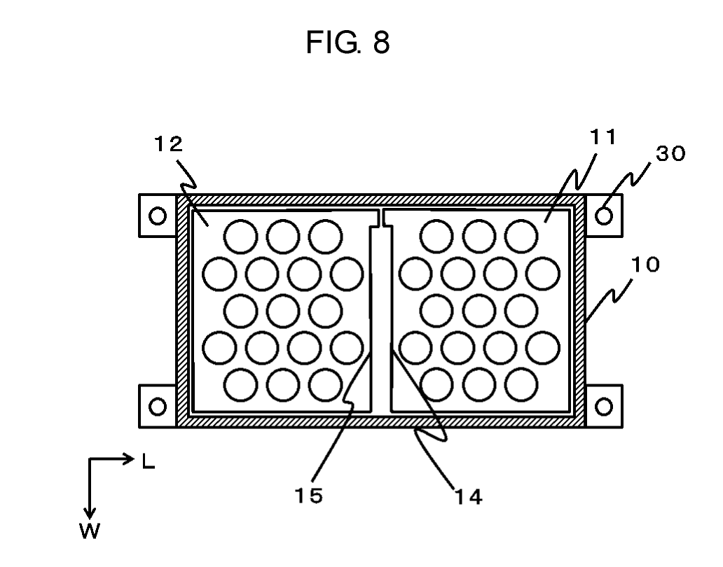

FIG. 8 is a sectional view taken along line A-A of a battery module according to a second exemplary embodiment.

In the first exemplary embodiment, the side surfaces of the battery blocks on sides to which external force 21 is applied have the cut-away parts. In the second exemplary embodiment, battery blocks having cut-away parts on side surfaces of the battery blocks on sides opposite to the sides to which external force 21 is applied will be described.

Battery case 10 houses first battery block 11 and second battery block 12. Battery block 11 includes cut-away part 14. Battery block 12 includes cut-away part 15. Each of the cut-away parts is formed in an L-shape in plan view of FIG. 8.

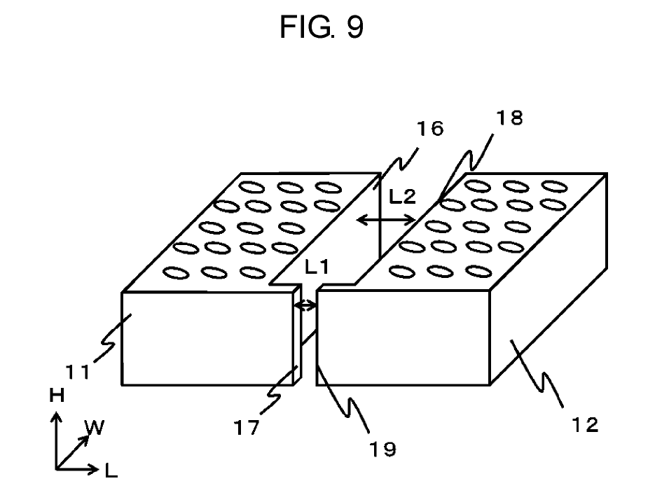

FIG. 9 is a perspective view of the battery blocks according to the second exemplary embodiment.

First battery block 11 has first side wall 16 and second side wall 17 on a side surface facing second battery block 12. Second battery block 12 has third side wall 18 and fourth side wall 19 on a side surface facing the first battery block 11. First side wall 16 constitutes cut-away part 14. Third side wall 18 constitutes cut-away part 15. Second side wall 17 and fourth side wall 19 constitute respective protrusions. The protrusion of the first battery block is a part protruding in length direction L from the side surface facing second battery block 12. The protrusion of the second battery block is a part protruding in length direction L from the side surface facing the first battery block.

First side wall 16 faces third side wall 18. A length (distance) in length direction L from first side wall 16 to third side wall 18 is defined as facing length L2.

Second side wall 17 faces fourth side wall 19. A length (distance) in length direction L from second side wall 17 to fourth side wall 19 is defined as facing length L1.

Facing length L1 is shorter than facing length L2. An area of first side wall 16 is larger than an area of second side wall 17. An area of third side wall 18 is larger than an area of fourth side wall 19.

Note that a partition wall can be provided between the facing side surfaces of first battery block 11 and second battery block 12. In a case where the partition wall is provided, a total of a length from fourth side wall 19 to the partition wall and a length from second side wall 17 to the partition wall is defined as facing length L1. A total of a length from third side wall 18 to the partition wall and a length from first side wall 16 to the partition wall is defined as facing length L2. Also in a case where the partition wall is provided, facing length L1 is shorter than facing length L2.

Note that in a case where second side wall 17 of first battery block 11 and fourth side wall 19 of second battery block 12 are in close contact with each other or integrated with each other, first side wall 16 and third side wall 18 may be formed such that facing length L2≠0 is satisfied.

A space surrounded by first side wall 16, third side wall 18, and battery case 10 is formed inside of battery case 10.

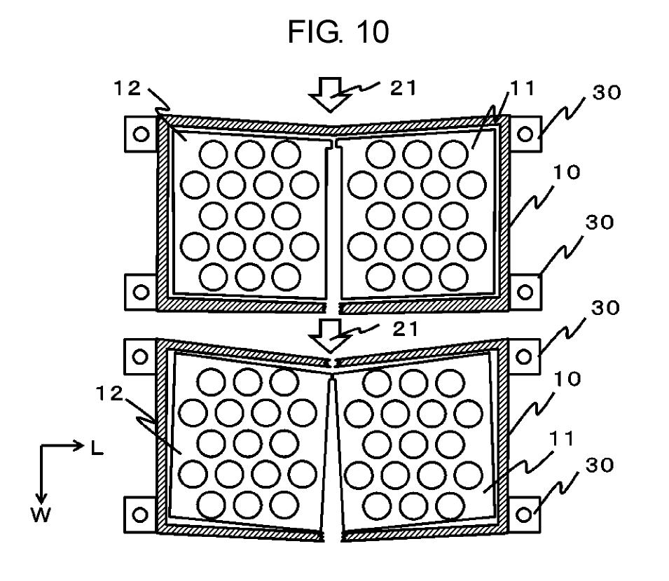

FIG. 10 is a sectional view taken along line A-A of FIG. 1 and illustrating the battery module according to the second exemplary embodiment when external force is applied to one of side surfaces of the battery module. Note that the “one of the side surfaces of the battery module” is synonymous with “one of side surfaces of battery case 10.”

When external force 21 is applied to the one of the side surfaces of battery case 10 in a direction of an arrow, strain is generated on the one of the side surfaces of battery case 10 which has received external force 21, and the one of the side surfaces of battery case 10 is compressed in width direction W.

An inner side surface of the one of the side surfaces of battery case 10 is compressed in width direction W until the inner side surface comes into contact with the battery blocks.

Lengths in width direction W of second side wall 17 and fourth side wall 19 are shorter than lengths in width direction W of first side wall 16 and third side wall 18, and therefore second side wall 17 and fourth side wall 19 are weak against force applied in width direction W. Accordingly, when the battery blocks are compressed in width direction W, second side wall 17 and fourth side wall 19 are more easily compressed in width direction W than other side surfaces of the battery blocks.

Facing length L2 between first side wall 16 and third side wall 18 increases toward the other side surface of battery case 10. End parts (angular parts) of the battery blocks being in contact with first side wall 16 and third side wall 18 transmit external force 21 to the inner side surface of the other side surface of battery case 10.

External force 21 is applied from the end parts (angular parts) of the battery blocks being in contact with first side wall 16 and third side wall 18 to an inner side surface of the other side surface of battery case 10 concentrically. Cracks are generated along height direction H on the other side surface of battery case 10 being in contact with the end parts (angular parts) of the battery blocks being in contact with first side wall 16 and third side wall 18.

Cracks are generated along height direction H also on the one of the side surfaces of battery case 10 in a vicinity to which external force 21 is applied.

When external force 21 further continues to be applied, cracks are generated along width direction W on side surfaces defined by length direction L and width direction W such that the cracks on the one of the side surfaces of battery case 10 are connected to the cracks on the other side surface. A whole circumference of battery case 10 ruptures, and battery case 10 collapses.

According to the above configuration, battery case 10 collapses such that the whole circumference ruptures, and thus it is possible to avoid application of external force 21 in an extent of generating breakage or internal short circuits in batteries 5.

According to the above configuration, since it is possible to control a rupture and collapse state of battery case 10, it is possible to suppress application of stress owing to deformation of battery case 10 to the batteries, and it is possible to prevent breakage of batteries 5 and internal short circuits of batteries 5 owing to the breakage.

### MODIFICATION OF SECOND EXEMPLARY EMBODIMENT

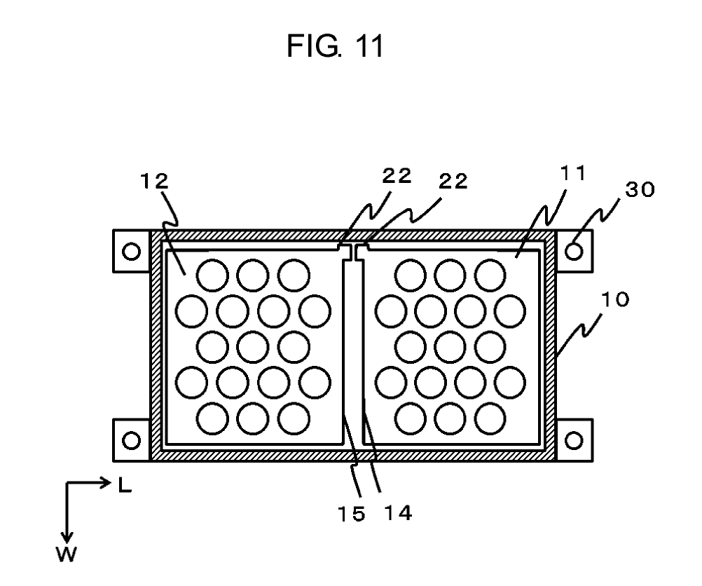

FIG. 11 is a sectional view taken along line A-A of a battery module according to a modification of the second exemplary embodiment. Parts different from the parts of the second exemplary embodiment will mainly be described.

First battery block 11 and second battery block 12 each have protrusion 22 protruding in width direction W and length direction L in plan view of FIG. 11. That is, while first battery block 11 and second battery block 12 have the respective protrusions protruding in width direction W in the second exemplary embodiment, a protrusion of first battery block 11 and a protrusion of second battery block 12 each have protrusion 22 protruding also in length direction L in the modification of the second exemplary embodiment. Protrusion 22 of first battery block 11 may be referred to as a first protrusion, and the protrusion of second battery block 11 may be referred to as a second protrusion.

Protrusions 22 may be formed at different positions in the first battery block and the second battery block.

When external force 21 is applied to an outer side surface of one of side surfaces of battery case 10, strain is generated toward the other side surface of battery case 10 on the one of the side surfaces of battery case 10 which has received external force 21. Battery case 10 is compressed in width direction W of battery case 10. Note that the one of the side surfaces of battery case 10 means a side surface of battery case 10 on a side provided with protrusions 22.

Battery case 10 is compressed until battery case 10 comes into contact with protrusions 22. Protrusions 22 come into contact with battery case 10, external force 21 is applied to protrusions 22, and protrusions 22 are compressed in width direction W.

By action of external force 21 transmitted to compressed protrusions 22, facing length L2 increases toward the other side surface of battery case 10.

Each of first battery block 11 and second battery block 12 is provided with protrusion 22, and thus external force 21 applied to the one of the side surfaces of battery case 10 can be concentrated on protrusions 22. First battery block 11 and second battery block 12 can more efficiently transmit external force 21 to the other side surface of battery case 10.

### THIRD EXEMPLARY EMBODIMENT

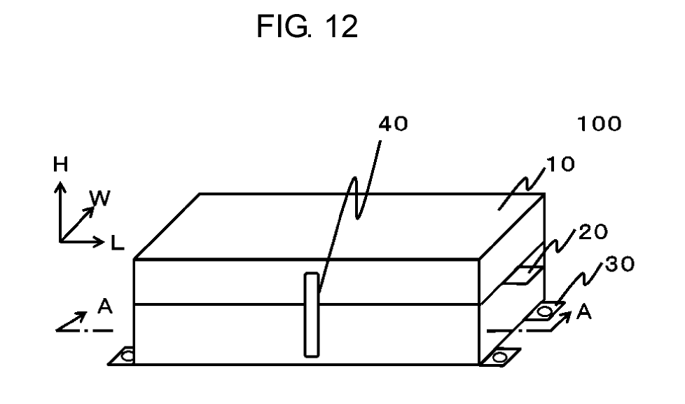

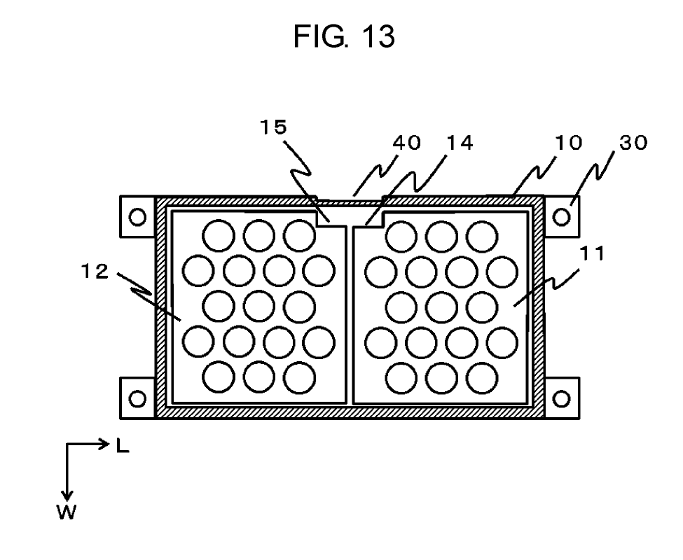

FIG. 12 is a perspective view illustrating a configuration of a battery module according to a third exemplary embodiment. FIG. 13 is a sectional view taken along line A-A of the battery module according to the third exemplary embodiment.

In the third exemplary embodiment, battery module 100 which makes battery case 10 itself easily rupture and in which it is possible to adjust a rupture place of battery case 10, will be described.

Battery case 10 has a thin-walled part 40 having a thickness in width direction W of battery case 10 partially thin, on an outer side surface of one of side surfaces. In a case where thin-walled part 40 is provided on a side surface of the battery case located on a plane defined by height direction H and length direction L, thin-walled part 40 may have any shape as long as height direction H of battery case 10 is a longitudinal direction of thin-walled part 40.

Thin-walled part 40 is provided, and thus in a case where external force 21 is applied to battery case 10, cracks can be generated from thin-walled part 40 in battery case 10, and it is possible to adjust a location where battery case 10 ruptures.

Thin-walled part 40 is provided between first battery block 11 and second battery block 12 to cause rupture of battery case 10, and thus external force 21 applied to the battery blocks can be transmitted efficiently to an inner side surface of the other side surface of battery case 10, and it is possible to prevent breakage of batteries 5.

Thin-walled part 40 may not be provided on an inner side surface of the one of the side surfaces of battery case 10, rather than on the outer side surface of the one of the side surfaces of battery case 10. Thin-walled parts 40 can also be provided on both the inner side surface and the outer side surface of the side surface of battery case 10. Additionally, thin-walled part 40 may be formed on a side surface defined by length direction L and width direction W of the battery blocks, among side surfaces of battery case 10.

Thin-walled part 40 may be formed in a slit shape. That is, thin-walled part 40 may be a fragile part having lower hardness than other parts of battery case 10.

In a case where thin-walled part 40 is formed in the slit shape, thin-walled part 40 may be used as a cooling port for cooling batteries 5 by air.

In a case where thin-walled part 40 has a plurality of slit shapes, rupture in height direction H of battery case 10 can be caused by making a length in height direction H of a slit shape in a vicinity where battery case 10 is desired to rupture longer than a length in height direction H of another slit shape. Therefore, it is possible to adjust a rupture place of battery case 10.

Note that a slit that is not involved in the adjustment of the rupture place can be used as a cooling hole for introducing air into battery case 10 and cooling the inside of the battery case.

Note that in the above respective exemplary embodiments, the exemplary embodiments using battery module 100 including the two battery blocks is described, but battery module 100 may include three or more battery blocks. In a case where battery module 100 includes the three or more battery blocks, a cut-away part may be provided in at least one interval between the battery blocks disposed side by side, or cut-away parts may be provided on both one of side surfaces of each battery block and the other side surface, or the cut-away parts may be provided alternately on the one of the side surfaces of each battery block and the other side surface.

### REFERENCE MARKS IN THE DRAWINGS

1 upper side battery case

2 lower side battery case

3 positive current collector

4 negative current collector

5 battery

6 battery holder

10 battery case

11 first battery block

12 second battery block

13 housing part

14 first cut-away part

15 second cut-away part

16 first side wall

17 second side wall

18 third side wall

19 fourth side wall

20 input/output terminal

21 external force

22 protrusion

30 fixing part

40 thin-walled part

100 battery module

1. A battery module comprising:
a first battery block that houses a plurality of batteries;
a second battery block that houses a plurality of batteries; and
a battery case that houses the first battery block and the second battery block such that the first battery block and the second battery block are disposed side by side, wherein
the plurality of batteries housed in the first battery block is housed in the first battery block such that longitudinal directions of the plurality of batteries are directed to the same direction,
the plurality of batteries housed in the second battery block is housed in the second battery block such that longitudinal directions of the plurality of batteries are directed to the same direction,
the first battery block and the second battery block are each polygonal in plan view when the plurality of batteries is viewed in the longitudinal directions,
the first battery block has a first cut-away part on a side surface facing the second battery block,
the second battery block has a second cut-away part on a side surface facing the first cut-away part such that the second cut-away part faces the first cut-away part, and
a space surrounded by the side surface on which the first battery block has the first cut-away part, the side surface on which the second battery block has the second cut-away part, and an inner side surface of the battery case, is provided.

2. The battery module according to claim 1, wherein
the first battery block has a first side wall and a second side wall on the side surface facing the second battery block,
the second battery block has a third side wall and a fourth side wall on the side surface facing the first battery block,
the first side wall faces the third side wall,
the second side wall faces the fourth side wall, and
a facing length between the first side wall and the third side wall has a longer part than a facing length between the second side wall and the fourth side wall.

3. The battery module according to claim 2, wherein
an area of the first side wall is larger than an area of the second side wall, and
an area of the third side wall is larger than an area of the fourth side wall.

4. The battery module according to claim 2, wherein
an area of the first side wall is smaller than an area of the second side wall, and an area of the third side wall is smaller than an area of the fourth side wall.

5. The battery module according to claim 2, wherein
a facing length between the first side wall and the third side wall decreases toward the second side wall and the fourth side wall.

6. The battery module according to claim 1, wherein
the first battery block further includes a first protrusion on the side surface facing the second battery block, and
the second battery block further includes a second protrusion on the side surface facing the first battery block,
the first protrusion protrudes in a direction parallel to the side surface facing the second battery block among side surfaces of the first battery block, and in a direction orthogonal to the longitudinal directions of the plurality of batteries,
the second protrusion protrudes in a direction parallel to the side surface facing the first battery block among side surfaces of the second battery block, and in a direction orthogonal to the longitudinal directions of the plurality of batteries, and
the first protrusion and the second protrusion are formed so as to be disposed side by side.

7. The battery module according to claim 1, wherein
the battery case further includes a fragile part having lower hardness than other parts of the battery case, on at least one side surface, and
the fragile part is disposed along a space of a boundary between the first battery block and the second battery block.

8. The battery module according to claim 7, wherein
the fragile part is an opening,
the battery case further has a cooling hole for introducing air into the battery case, on the side surface having the fragile part, and
the opening is longer than the cooling hole in a length in axial directions of the batteries.

9. The battery module according to claim 7, wherein
a space between the first cut-away part and the second cut-away part is formed at a center of the battery case, and the fragile part is formed at a center of the side surface of the battery case.

10. The battery module according to claim 4, wherein
a facing length between the first side wall and the third side wall decreases toward the second side wall and the fourth side wall.

11. The battery module according to claim 2, wherein
the first battery block further includes a first protrusion on the side surface facing the second battery block, and
the second battery block further includes a second protrusion on the side surface facing the first battery block,
the first protrusion protrudes in a direction parallel to the side surface facing the second battery block among side surfaces of the first battery block, and in a direction orthogonal to the longitudinal directions of the plurality of batteries,
the second protrusion protrudes in a direction parallel to the side surface facing the first battery block among side surfaces of the second battery block, and in a direction orthogonal to the longitudinal directions of the plurality of batteries, and
the first protrusion and the second protrusion are formed so as to be disposed side by side.

12. The battery module according to claim 3, wherein
the first battery block further includes a first protrusion on the side surface facing the second battery block, and
the second battery block further includes a second protrusion on the side surface facing the first battery block,
the first protrusion protrudes in a direction parallel to the side surface facing the second battery block among side surfaces of the first battery block, and in a direction orthogonal to the longitudinal directions of the plurality of batteries,
the second protrusion protrudes in a direction parallel to the side surface facing the first battery block among side surfaces of the second battery block, and in a direction orthogonal to the longitudinal directions of the plurality of batteries, and
the first protrusion and the second protrusion are formed so as to be disposed side by side.
